(19) United States
(12) Patent Application Publication
(10) Pub. No.: US 2002/0194594 A1
(43) Pub. Date: Dec. 19, 2002

(54) Methods and apparatus for broadcasting messages for receipt by specific recipients in a network

(75) Inventor: Christopher Poli, Doylestown, PA (US)

Correspondence Address: LAW OFFICE OF BARRY R LIPSITZ, 755 MAIN STREET, MONROE, CT, 06468, US

(73) Assignee: General Instrument Corporation, Horsham, PA (US)

(21) Appl. No.: 09/884,648

(22) Filed: Jun. 19, 2001

(51) Int. Cl. H04N 7/025

(52) U.S. Cl. 725/34

(57) ABSTRACT

The invention provides for delivery of broadcast messages to a sub-population of recipients in a network. The network has multiple interim processing points, each with a plurality of recipients (clients) associated therewith. Processor 205 at message source 100 generates a broadcast message and encases the broadcast message in a message envelope. The message envelope directs the broadcast message to the specific interim processing point (e.g., 110A). Transmitter 210 transmits the message envelope containing the broadcast message over the network to the specific interim processing point 110A. Receiver 215 receives the message envelope containing the broadcast message if the message envelope is associated with that interim processing point. Processor 220 at each interim processing point 110A strips the message envelopes associated therewith from the received broadcast messages. Transmitter 225 forwards broadcast messages to recipients (clients 120A, 121A, . . . , and 150A) associated with that interim processing point.

### BACKGROUND OF THE INVENTION

The present invention relates generally to message delivery in a network. More specifically, the invention relates to the delivery of broadcast messages to a particular sub-population of receivers in a network. In particular, the invention provides methods and systems for limiting the receipt of broadcast messages to a specific population of set-top terminals in a television system.

In a typical cable television system, the messages sent to a set-top terminal may be divided into three categories, a unit addressed message, a multicast message, and a broadcast message. A unit addressed message is a message addressed to a specific set-top terminal. Unit addressed messages may contain, for example, authorization information for a specific set of services ordered by a user. A multicast message is a message addressed to a specific population of set-top terminals in the cable system. A multicast message may be a message meant for all set-top terminals associated with a particular headend in a cable television system, and may provide, for example, a channel map for those set-top terminals. A broadcast message is a message addressed to every set-top terminal in the system, regardless of the headend the terminal is associated with. Broadcast messages may contain, for example, any information shared among all terminals in a system.

Certain set-top terminals, such as the Bootloader terminal developed by General Instrument Corporation, the assignee of the present invention, cannot receive a multicast message. The Bootloader terminal is provided at manufacture only with a download platform and the ability to receive broadcast messages. The Bootloader terminal can be initialized and configured once installed in the field. This simplifies the manufacturing process and allows the same set-top terminal to be used in virtually any cable or satellite television system. Once installed, the particular configuration information needed for the terminal to operate in that television system is downloaded by the terminal. The Bootloader terminal is described in detail in co-pending commonly assigned U.S. patent application Ser. No. 09/544,447 entitled “Method and System for Identifying and Downloading Appropriate Software of Firmware Specific to A Particular Model of Set-Top Box in A Cable Television System” filed on Apr. 7, 2000 and owned by General Instrument Corporation of Horsham, Pennsylvania, the assignee of the present invention.

However, delivering messages to terminals such as the Bootloader terminal becomes problematic in large satellite or cable television systems with multiple headends. In such a system, it may be desirable to send messages only to the set-top terminals associated with a particular headend. As such terminals can only receive broadcast messages, it may be impractical to send a broadcast message (i.e. a message to all terminals) when only those terminals associated with a particular headend are intended to receive the message.

It would be advantageous to provide methods and apparatus for delivering broadcast messages to only particular terminals associated with a particular headend. It would be particularly advantageous to provide a message filter to allow only selected terminals to receive a broadcast message. It would be further advantageous to provide a message envelope which encloses the broadcast message and directs the broadcast message to a specific headend. It would be even further advantageous to strip the envelope from the broadcast message at the headend so that the broadcast message can then be forwarded to all the terminals associated with that headend.

The methods and systems of the present invention provide the foregoing and other advantages.

### SUMMARY OF THE INVENTION

The present invention relates to message delivery in a network. In particular, broadcast messages may be transmitted for receipt by specific recipients in a network. The network has multiple interim processing points. A plurality of recipients (also referred to herein as “clients” or “client devices”) are associated with each interim processing point. A first processor at a message source is provided for generating a broadcast message and encasing the broadcast message in a message envelope. The message envelope associates the broadcast message with a specific interim processing point and directs the message envelope containing the broadcast message to the specific interim processing point. A first transmitter at the message source is provided for transmitting the message envelope containing the broadcast message over the network to the specific interim processing point. A receiver at each interim processing point is provided for receiving the message envelope containing the broadcast message if the message envelope is associated with that specific interim processing point. A second processor at each interim processing point is provided for stripping message envelopes associated therewith from the broadcast messages. A second transmitter is provided at each interim processing point for forwarding broadcast messages stripped at that processing point to recipients associated with the specific interim processing point.

The message source may comprise a national control for a television system having multiple headends. The interim processing points may comprise television system headends and the recipients may comprise set-top terminals.

### BRIEF DESCRIPTION OF THE DRAWINGS

The present invention will hereinafter be described in conjunction with the appended drawing figures, wherein like numerals denote like elements, and:

FIG. 1 is a block diagram of an exemplary embodiment of the invention;

FIG. 2 illustrates the packaging (“encasing”) of messages in accordance with an exemplary embodiment of the invention;

FIG. 3 is a more detailed block diagram of an implementation of the invention; and

FIG. 4 is a block diagram of a further exemplary embodiment of the invention.

### DETAILED DESCRIPTION OF THE INVENTION

The ensuing detailed description provides preferred exemplary embodiments only, and is not intended to limit the scope, applicability, or configuration of the invention. Rather, the detailed description of the preferred exemplary embodiments will provide those skilled in the art with an enabling description for implementing a preferred embodiment of the invention. It should be understood that various changes may be made in the function and arrangement of elements without departing from the spirit and scope of the invention as set forth in the appended claims.

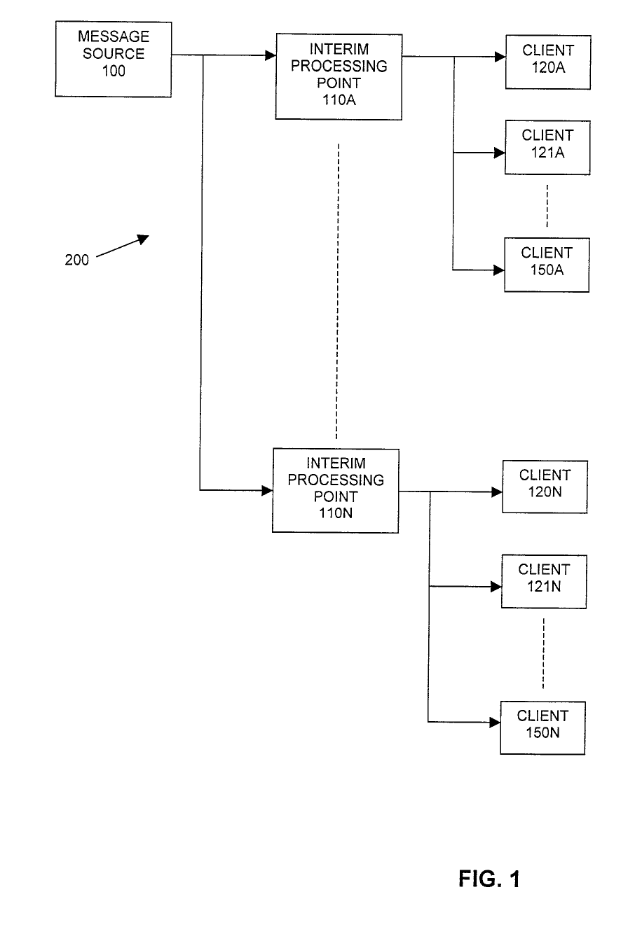

In an exemplary embodiment of the invention as shown in FIG. 1, broadcast messages are transmitted for receipt by specific recipients (clients) in a network generally designated 200. The network 200 has multiple interim processing points (e.g., 110A, . . . , 110N). A plurality of recipients are associated with each interim processing point. For example, FIG. 1 shows interim processing point 110A as having recipients (e.g., clients 120A, 121A, . . . , and 150A) associated therewith. Interim processing point 110N is shown as having recipients 120N, 121N, . . . , and 150N. It should be appreciated that there may be any number of interim processing points in network 200, as well as any number of recipients associated with each interim processing point.

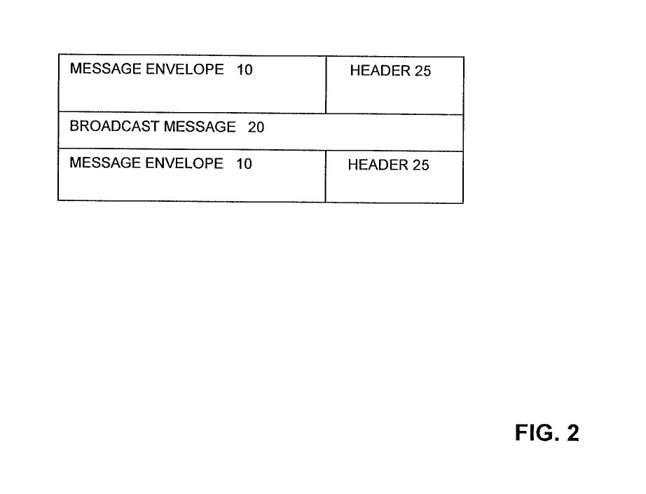

A broadcast message is generated at the message source 100. As shown in FIG. 2, the broadcast message 20 is encased in a message envelope 10 for directing the broadcast message 20 to a specific interim processing point. The message envelope 10 containing the broadcast message 20 is transmitted from the message source to the specific interim processing point. Once received at the specific interim processing point, the message envelope 10 is stripped from the broadcast message 20. The broadcast message 20 can then be forwarded from the specific interim processing point to recipients associated with the specific interim processing point.

As shown in FIG. 2, the message envelope 10 may include a header 25 containing an address for the specific interim processing point. In this manner, broadcast messages can be directed to specific interim processing points, and consequently to specific client devices. Thus, the invention allows broadcast messages to be reformatted for selective distribution. This effectively changes the broadcast messages to directed messages, without any need to change the operation of upstream components which continue to operate as though such messages are really broadcast to all terminals, in the classic sense of a broadcast message.

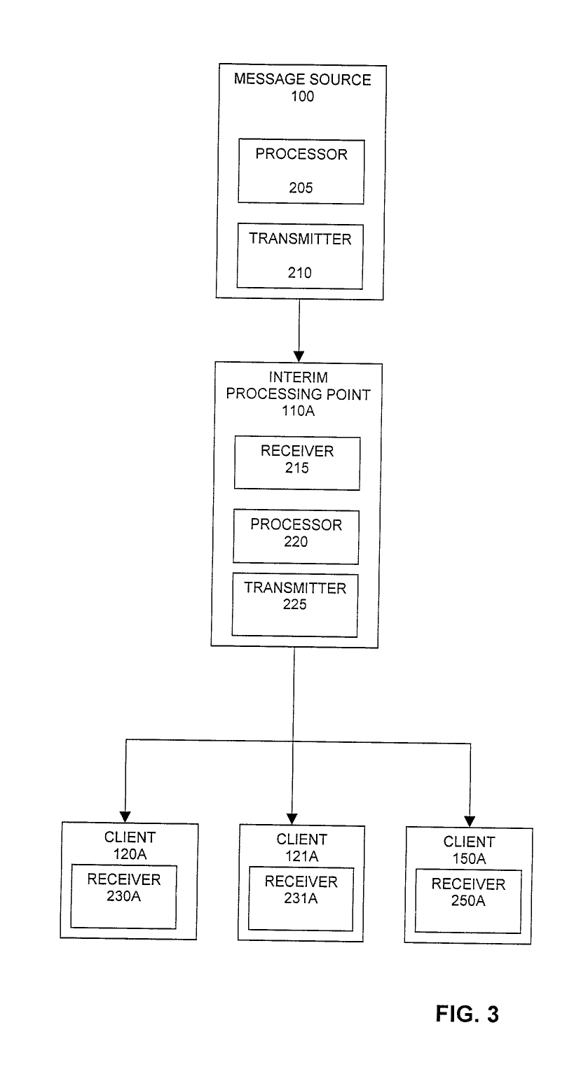

FIG. 3 shows a block diagram of the invention. For simplicity, only one interim processing point 110A and its associated recipients (120A, 121A, . . . , 150A) are shown. A first processor 205 at a message source 100 is provided for generating a broadcast message and encasing the broadcast message in a message envelope (as described in connection with FIG. 2). The message envelope associates the broadcast message with a specific interim processing point (in this example interim processing point 110A) and directs the message envelope containing the broadcast message to the specific interim processing point (e.g., 110A). A first transmitter 210 at the message source 100 is provided for transmitting the message envelope containing the broadcast message over the network 200 to the specific interim processing point (e.g., 110A). A receiver 215 at each interim processing point is provided for receiving the message envelope containing the broadcast message if the message envelope is associated with that specific interim processing point. A second processor 220 at each interim processing point is provided for stripping message envelopes associated therewith from the broadcast messages. A second transmitter 225 is provided at each interim processing point for forwarding broadcast messages stripped at that processing point to recipients (clients 120A, 121A, . . . , and 150A) associated with the specific interim processing point. The recipients (120A, 121A, . . . , and 150A) may have receivers (e.g., 230A, 231A, . . . , and 250A) for receiving the broadcast messages.

The interim processing points 110A, . . . 110N may comprise network nodes (e.g., cable television headends, network routers, and the like) and the recipients (e.g., clients 120A, 121A, . . . , 150A and clients 120N, 121N, . . . , 150N) may comprise client devices (e.g., personal computers, television set-top terminals, televisions, printers, Internet appliances, and the like).

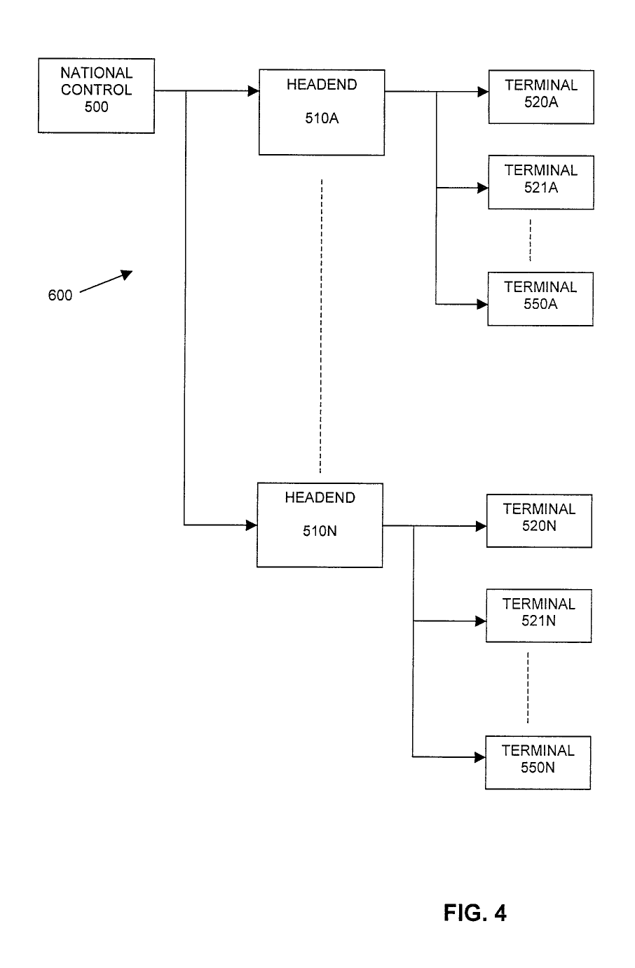

In an alternate embodiment as shown in FIG. 4, the message source may comprise a national control 500 for a television system generally designated 600 having multiple headends. The interim processing points may comprise television system headends (510A, . . . , 510N) and the recipients may comprise set-top terminals (520A, 521A, . . . , 550A and, 520A, 521A, . . . , 550N). The broadcast message (20 of FIG. 2) may contain pre-configuration information for the set-top terminals. The pre-configuration information may allow the set-top terminals(e.g., 520A, 521A, . . . , 550A) to acquire configuration information, platform layer information, control channel information, application information, authorization information, and/or system information. The television system 600 may be a satellite television system, a cable television system, or a combination satellite and cable television system. The message envelope may include a header containing the address for the specific headend.

The message envelope may be stripped from the broadcast message by a filter. The filter compares, for example, received header information (e.g., contained in header 25 of the broadcast message as shown in FIG. 2) to predefined message envelope codes that are specific to the particular interim processing point associated with the filter. In this manner, the filter can identify message envelopes associated with that particular interim processing point and strip the message envelopes from the broadcast messages intended for the client devices associated with that particular interim processing point. The filter may be implemented in the processor 220 located at each interim processing point. The filter may be easily implemented in software and/or firmware as will be apparent to those skilled in the art.

In a cable television system application as described in connection with FIG. 4, the invention enables the efficient delivery of broadcast messages to simple terminals that are configured to receive only broadcast messages. By encasing the broadcast message in a message envelope, the broadcast message can be directed to a specific headend for distribution to the set-top terminals associated with that headend. In this manner, receipt of the broadcast message can be limited to a specific population of the set-top terminals in a television system. Moreover, the present invention enables national control of set-top terminal configuration, as illustrated in FIG. 4.

It should now be appreciated that the present invention provides advantageous methods and systems for delivering broadcast messages in a network only to specific recipients by encasing the broadcast message in a message envelope, which can be addressed to a specific interim processing point so that the delivery of a broadcast message can be limited to only those recipients associated with that particular interim processing point. Such methods and systems provide a way to advantageously address recipients, such as a simplified set-top terminal, which are only designed to receive broadcast messages.

Although the invention has been described in connection with various illustrated embodiments, numerous modifications and adaptations may be made thereto without departing from the spirit and scope of the invention as set forth in the claims.

What is claimed is:

1. A method for transmitting broadcast messages for receipt by specific recipients in a network, said network having multiple interim processing points, comprising the steps of:
generating a broadcast message;
encasing the broadcast message in a message envelope for directing the broadcast message to a specific interim processing point;
transmitting the message envelope containing the broadcast message from the message source to the specific interim processing point;
stripping the message envelope from the broadcast message; and
forwarding the broadcast message from the specific interim processing point to recipients associated with the specific interim processing point.

2. A method in accordance with claim 1, wherein:
the interim processing points comprise network nodes; and
the recipients comprise client devices.

3. A method in accordance with claim 1, wherein the message envelope includes a header containing an address for the specific interim processing point.

4. A method in accordance with claim 1, wherein:
the message source comprises a national control for a television system having multiple headends;
the interim processing points comprise television system headends; and
the recipients comprise set-top terminals.

5. A method in accordance with claim 4, wherein:
the broadcast message contains pre-configuration information for said set-top terminals.

6. A method in accordance with claim 5, wherein:
said pre-configuration information allows said set-top terminals to acquire at least one of configuration information, platform layer information, control channel information, application information, authorization information, and system information.

7. A method in accordance with claim 4, wherein the television system comprises one of a satellite television system, a cable television system, or a combination satellite and cable television system.

8. A method in accordance with claim 4, wherein the message envelope includes a header containing the address for the specific headend.

9. A method in accordance with claim 1, wherein the message envelope is stripped from the broadcast message by a filter.

10. A system for transmitting broadcast messages for receipt by specific recipients in a network, said network having multiple interim processing points, comprising:
a first processor at a message source for generating a broadcast message and encasing the broadcast message in a message envelope, wherein the message envelope associates the broadcast message with a specific interim processing point;
a first transmitter at the message source for transmitting the message envelope containing the broadcast message over the network;
a receiver at each interim processing point for receiving the message envelope containing the broadcast message if the message envelope is associated with that specific interim processing point;
a second processor at each interim processing point for stripping message envelopes associated therewith from the broadcast messages; and
a second transmitter at each interim processing point for forwarding broadcast messages stripped at that processing point to recipients associated with the specific interim processing point.

11. A system in accordance with claim 10, wherein:
the interim processing points comprise network nodes; and
the recipients comprise client devices.

12. A system in accordance with claim 10, wherein the message envelope includes a header containing an address for the specific interim processing point.

13. A system in accordance with claim 10, wherein:
the message source comprises a national control for a television system having multiple headends;
the interim processing points comprise television system headends; and
the recipients comprise set-top terminals.

14. A system in accordance with claim 13, wherein:
the broadcast message contains pre-configuration information for said set-top terminals.

15. A system in accordance with claim 14, wherein:
said pre-configuration information allows said set-top terminals to acquire at least one of configuration information, platform layer information, control channel information, application information, authorization information, and system information.

16. A system in accordance with claim 13, wherein the television system comprises one of a satellite television system, a cable television system, or a combination satellite and cable television system.

17. A system in accordance with claim 13, wherein the message envelope includes a header containing the address for the specific headend.

18. A system in accordance with claim 10, wherein the message envelope is stripped from the broadcast message by a filter.
